(19) United States
(12) Patent Application Publication
(10) Pub. No.: US 2025/0259415 A1
(43) Pub. Date: Aug. 14, 2025

(54) IMAGE PROCESSING APPARATUS, IMAGE PROCESSING METHOD, AND NON-TRANSITORY COMPUTER READABLE MEDIUM

(71) Applicants: CANON KABUSHIKI KAISHA, Tokyo (JP); CANON MEDICAL SYSTEMS CORPORATION, Tochigi (JP)

(72) Inventor: Takahiro KUROYAMA, Kanagawa (JP)

(21) Appl. No.: 19/050,394

(22) Filed: Feb. 11, 2025

(30) Foreign Application Priority Data
Feb. 14, 2024 (JP) 2024-020566

(51) Int. Cl. G06V 10/72; G06V 10/26; G06V 10/28

(52) U.S. Cl. CPC G06V 10/72; G06V 10/26; G06V 10/28; G06V 2201/031

(57) ABSTRACT

An image processing apparatus executes image acquisition processing of acquiring an image taken of an object, executes first extraction processing of extracting a first region in correspondence with a region of the object by using the image, executes parameter acquisition processing of acquiring a parameter for performing normalization of the image, based on a pixel value of a pixel in the first region and based on a contribution degree indicating a probability that the pixel is included in the object, executes normalization processing of acquiring a normalized image created by normalizing the image by using the image and the parameter, and executes second extraction processing of more finely extracting a region of the object than the first region by using the normalized image.

### BACKGROUND OF THE INVENTION

### Field of the Invention

The present invention relates to an image processing apparatus, an image processing method, and a non-transitory computer readable medium.

### Description of the Related Art

Conventionally, images of an object such as a heart taken by an imaging apparatus such as an ultrasonic diagnostic apparatus may depict the object on an image at different pixel values and contrasts, depending on imaging conditions. Various methods have been proposed to extract regions of objects from such images.

For example, in Japanese Patent Application Laid-open No. 2015-073832, when extracting a region of a left ventricle in an echocardiogram (a cardiac ultrasound image) captured by an ultrasonic diagnostic apparatus, anatomical feature points such as a center point of the left ventricle are first extracted. Then, pixel values of pixels that are thought to be in the left ventricle are acquired from the pixel values around the extracted anatomical feature points, and the pixel values of the image are normalized based on the acquired pixel values. Accordingly, an image, in which a magnitude and a contrast of the pixel values of the left ventricular region on the image are aligned (normalized) to a predetermined value, is acquired and the image is used to extract the left ventricular region.

However, the method described in Japanese Patent Application Laid-open No. 2015-073832 extracts feature points within an object, normalizes the image based on pixel values of pixels that are considered to be within the region from pixel values around the extracted feature points, and extracts the region of the object.

Therefore, pixels that are considered to be within the region may include pixels in a region that are inappropriate for the object. As a result, it may not be possible to normalize the image in a favorable manner and perform accurate region extraction.

### SUMMARY OF THE INVENTION

The technique according to the present disclosure has been devised in consideration thereof and an object of the disclosure is to improve accuracy of region extraction of an object with respect to an image taken of an object.

According to some embodiments, an image processing apparatus includes a processor; and a memory storing a program which, when executed by the processor, causes the image processing apparatus to execute image acquisition processing of acquiring an image taken of an object, execute first extraction processing of extracting a first region in correspondence with a region of the object by using the image, execute parameter acquisition processing of acquiring a parameter for performing normalization of the image, based on a pixel value of a pixel in the first region and based on a contribution degree indicating a probability that the pixel is included in the object, execute normalization processing of acquiring a normalized image created by normalizing the image by using the image and the parameter, and execute second extraction processing of more finely extracting a region of the object than the first region by using the normalized image. In addition, according to some embodiments, an image processing apparatus includes a processor; and a memory storing a program which, when executed by the processor, causes the image processing apparatus to execute image acquisition processing of acquiring an image taken of an object, execute first extraction processing of extracting a region of the object as a first region by using the image, execute parameter acquisition processing of acquiring a parameter for performing normalization of the image, based on a partial region that is a part of the first region, execute normalization processing of acquiring a normalized image created by normalizing the image by using the image and the parameter, and execute second extraction processing of extracting a region of the object by using the normalized image.

According to some embodiments, an image processing method includes an image acquisition step of acquiring an image taken of an object; a first extraction step of extracting a first region in correspondence with a region of the object by using the image; a parameter acquisition step of acquiring a parameter for performing normalization of the image, based on a pixel value of a pixel in the first region and based on a contribution degree indicating a probability that the pixel is included in the object; a normalization step of acquiring a normalized image created by normalizing the image by using the image and the parameter; and a second extraction step of more finely extracting a region of the object than the first region by using the normalized image. In addition, according to some embodiments, an image processing method includes an image acquisition step of acquiring an image taken of an object; a first extraction step of extracting a region of the object as a first region by using the image; a parameter acquisition step of acquiring a parameter for performing normalization of the image, based on a partial region that is a part of the first region; a normalization step of acquiring a normalized image created by normalizing the image by using the image and the parameter; and a second extraction step of extracting a region of the object by using the normalized image.

Further features of the present invention will become apparent from the following description of exemplary embodiments with reference to the attached drawings.

### BRIEF DESCRIPTION OF THE DRAWINGS

FIG. 1 is a block diagram showing a schematic configuration of an image processing apparatus according to a first embodiment.

FIG. 2 is a flow chart of processing executed by the image processing apparatus according to the first embodiment.

FIGS. 3A to 3D are diagrams showing an example of an image acquired by the image processing apparatus according to the first embodiment.

FIG. 4 is a block diagram showing a schematic configuration of an image processing apparatus according to a second embodiment.

FIG. 5 is a flow chart of processing executed by the image processing apparatus according to the second embodiment.

FIG. 6 is a diagram showing an example of an image of an extracted region acquired by the image processing apparatus according to the second embodiment.

FIG. 7 is a block diagram showing a schematic configuration of an image processing apparatus according to a third embodiment.

FIG. 8 is a flow chart of processing executed by the image processing apparatus according to the third embodiment.

FIG. 9 is a diagram showing an example of an image of an extracted region acquired by the image processing apparatus according to the third embodiment.

FIG. 10 is a block diagram showing a schematic configuration of an image processing apparatus according to a fourth embodiment.

FIG. 11 is a flow chart of processing executed by the image processing apparatus according to the fourth embodiment.

### DESCRIPTION OF THE EMBODIMENTS

Hereinafter, embodiments of an image processing apparatus disclosed in the present specification will be described with reference to the drawings. It should be noted that same or similar components, members, and processing steps that are shown in the respective drawings will be denoted by same reference signs and redundant descriptions will be omitted as deemed appropriate. It should also be noted that, when appropriate, the components, the members, and the processing steps will be displayed in the respective drawings with parts thereof being omitted.

### First Embodiment

An image processing apparatus according to a first embodiment is an apparatus that acquires an image in which an object is depicted as an input image and extracts a region of the object from the input image. The image processing apparatus according to the present embodiment takes, as an example, a case where an echocardiogram taken during an examination of the heart (echocardiography) by an ultrasound image diagnostic apparatus is used as input, and using the right ventricle in the input image as the object, extracts a region of the right ventricle from the input image.

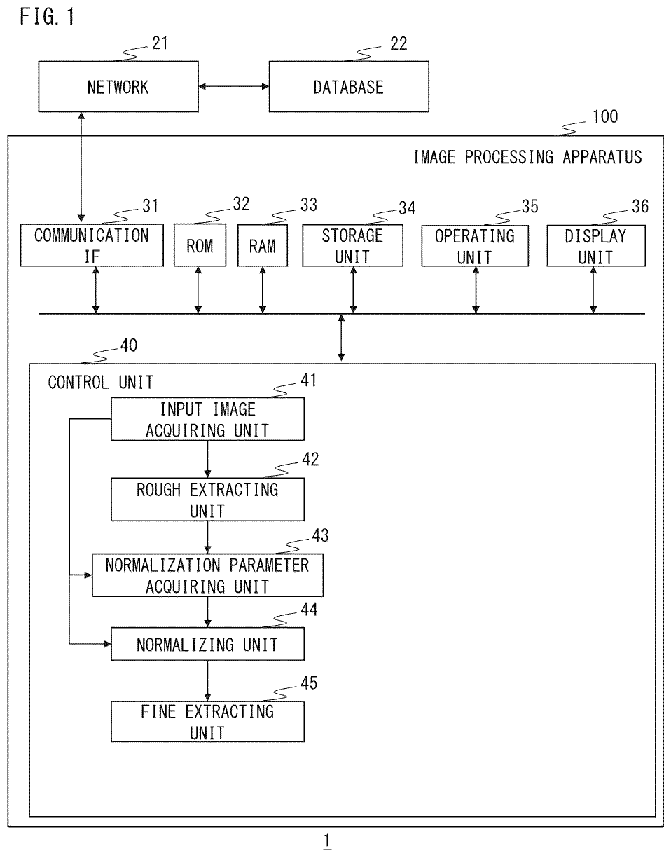

Hereinafter, a configuration and processing of the image processing apparatus according to the present embodiment will be described with reference to FIG. 1. FIG. 1 is a block diagram showing a configuration example of an image processing system (also referred to as a medical image processing system) which includes the image processing apparatus according to the present embodiment. An image processing system 1 includes an image processing apparatus 100 and a database 22.

The image processing apparatus 100 is communicatively connected to the database 22 via a network 21. For example, the network 21 includes a LAN (Local Area Network) or a WAN (Wide Area Network).

The database 22 stores and manages a plurality of images and information. Information managed by the database 22 includes images (input image, processing object image) to be input to the image processing apparatus 100 and information (structure and parameters of model) of each estimator used during extraction by a rough extracting unit 42 and a fine extracting unit 45 to be described later. Note that the information on the estimators may be stored in an internal storage (a ROM 32 or a storage unit 34) of the image processing apparatus 100 instead of the database 22. The image processing apparatus 100 is capable of acquiring data stored in the database 22 via the network 21.

The image processing apparatus 100 includes a communication IF (Interface) 31, the ROM (Read Only Memory) 32, a RAM (Random Access Memory) 33, the storage unit 34, an operating unit 35, a display unit 36, and a control unit 40.

The communication IF 31 is a communicating unit which is constituted of a LAN card or the like and which realizes communication between an external apparatus (for example, the database 22) and the image processing apparatus 100. The ROM 32 is constituted of a nonvolatile memory or the like and stores various programs and various kinds of data. The RAM 33 is constituted of a volatile memory or the like and is used as a work memory that temporarily stores a program being executed and data. The storage unit 34 is constituted of an HDD (Hard Disk Drive) or the like and stores various programs and various kinds of data. The operating unit 35 is constituted of a keyboard, a mouse, a touch panel, or the like and inputs an instruction from a user (for example, a physician or a medical technologist) to various apparatuses. The display unit 36 is constituted of a display or the like and displays various kinds of information to the user.

The control unit 40 is constituted of a CPU (Central Processing Unit) or a dedicated or general-purpose processor. The control unit 40 may be constituted of a GPU (Graphics Processing Unit) or an FPGA (Field-Programmable Gate Array). Alternatively, the control unit 40 may be constituted of an ASIC (Application Specific Integrated Circuit) or the like. The control unit 40 includes an input image acquiring unit 41, the rough extracting unit 42, a normalization parameter acquiring unit 43, a normalizing unit 44, and the fine extracting unit 45 to be described later.

The input image acquiring unit 41 acquires, from the database 22 or the storage unit 34, an image (input image) of a processing object to be input to the image processing apparatus 100. Note that the input image acquiring unit 41 may acquire an input image directly from a modality such as an ultrasound image diagnostic apparatus, in which case the image processing apparatus 100 may be implemented in the modality as a part of the modality's functionality.

The rough extracting unit 42 is a first extracting unit which extracts a region of the object that is an extraction object from the input image acquired by the input image acquiring unit 41 using a first estimator acquired from the database 22 or the storage unit 34. The region extracted by the rough extracting unit 42 is a rough extraction result of the region of the object from the input image.

The normalization parameter acquiring unit 43 is a contribution degree acquiring unit which acquires a pixel value of a pixel based on the object region being a first region extracted by the rough extracting unit 42 and which acquires a contribution degree that represents a magnitude of an influence (contribution) exerted by the pixel on the calculation of a normalization parameter. In addition, the normalization parameter acquiring unit 43 acquires the normalization parameter to be used in the normalizing unit 44 to be described later by calculating the normalization parameter based on the pixel value and the contribution degree. The normalization parameter acquiring unit 43 is configured to acquire a contribution degree with respect to at least a pixel corresponding to the object region being the first region.

The normalizing unit 44 performs normalization processing of the pixel value of the input image using the normalization parameter acquired by the normalization parameter acquiring unit 43 and generates a normalized image using the normalized pixel value.

The fine extracting unit 45 is a second extracting unit which, with respect to the normalized image generated by the normalizing unit 44, finely extracts the region of the object that is an extraction object using a second estimator acquired from the database 22 or the storage unit 34. Note that the fine extracting unit 45 is a specific mode of an estimating unit that performs estimation with respect to a normalized image.

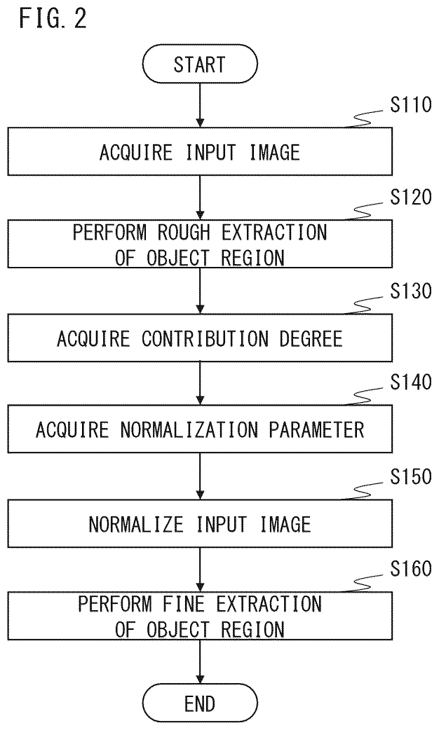

Next, each step of an image processing method in an example of processing executed by the image processing apparatus 100 according to the present embodiment will be described in detail with reference to the flow chart shown in FIG. 2. As an example, the control unit 40 of the image processing apparatus 100 starts the following processing based on a user's input from the operating unit 35.

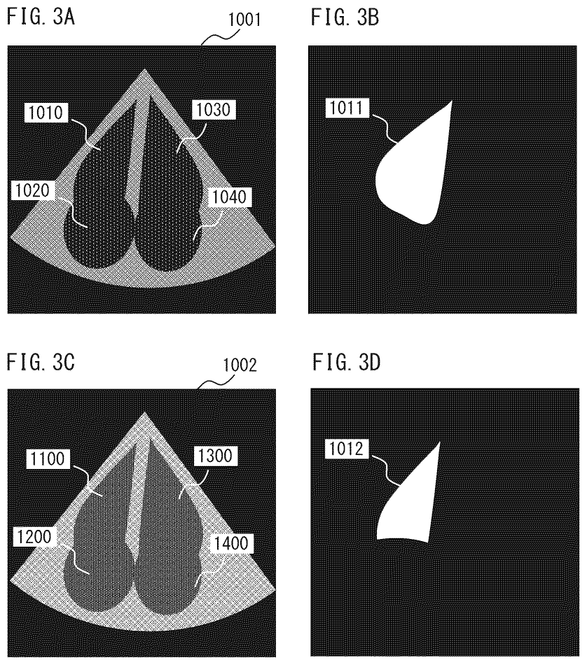

(Step S110: Acquisition of Input Image) In step S110, the input image acquiring unit 41 acquires an input image designated by the user via the operating unit 35 from the database 22 and stores the acquired input image in the storage unit 34. FIG. 3A shows an example of an input image 1001 acquired by the input image acquiring unit 41 in step S110. The input image 1001 that is an apical four chamber view depicts a subject's right ventricle 1010, right atrium 1020, left ventricle 1030, and left atrium 1040.

In the present embodiment, the input image acquiring unit 41 acquires an echocardiogram of the subject captured in echocardiography as an input image from the database 22. Note that the input image acquiring unit 41 may acquire an input image by methods other than acquiring the input image from the database 22. For example, the input image acquiring unit 41 may be configured to sequentially acquire, as input images, echocardiograms that are captured from time to time by the ultrasonic diagnostic apparatus. In addition, the control unit 40 may display the input image acquired in step S110 on the display unit 36.

(Step S120: Rough Extraction of Object Region) In step S120, the rough extracting unit 42 acquires a first estimator for estimating, using the input image acquired in step S110 as input, a region of the object in the image from the storage unit 34. In addition, the rough extracting unit 42 inputs the input image acquired in step S110 to the first estimator and extracts the region of the object that is an extraction object from the input image by rough extraction. In the present embodiment, the roughly extracted rough extraction region may sometimes be referred to as a first region.

Processing of rough extraction that is executed in the present step will now be described. In the present embodiment, an estimator for extracting a right ventricular region uses a method based on a convolutional neural network (CNN) which is a type of machine learning and which is a machine learning model based on deep learning. In other words, a relationship between an echocardiogram and a right ventricular region in the echocardiogram is learned using a CNN in advance. Subsequently, using the trained CNN, with respect to each pixel of the echocardiogram, the rough extracting unit 42 calculates a likelihood representing a probability that the pixel is the right ventricular region as a value that is equal to or greater than 0 and equal to or less than 1, and using a certain value such as 0.5 as a threshold, the rough extracting unit 42 adopts pixels with a likelihood of at least the threshold as a rough extraction region (first region) of the right ventricle. Therefore, in the present embodiment, a region with a likelihood that is equal to or greater than 0.5 can be a region that overlaps with the object region extracted by rough extraction or a region within the object region extracted by rough extraction. The likelihood that represents a probability that a pixel of interest in the echocardiogram is included in the right ventricular region as described above may sometimes be referred to as indicating a degree of probability that the pixel of interest in the echocardiogram is included in the right ventricular region. In other words, the likelihood that represents a probability that a pixel of interest in the echocardiogram is included in the right ventricular region being at least a predetermined threshold may sometimes be referred to as the probability that the pixel of interest in the echocardiogram is included in the right ventricular region being at least a predetermined probability. In addition, the inclusion of a pixel of interest in the object region may be considered an inclusion in the object region so as to include a mode having coordinates corresponding to an interior of the object and a mode having coordinates corresponding to a peripheral portion that constitutes a boundary between the inside and outside of the object. Furthermore, the inclusion of a pixel of interest in the object means that there is a mode in which coordinates of the pixel of interest are included in a coordinate group (data set) of an internal region of the object including a periphery of the object. In addition, in step S120, a processed image acquired by subjecting an input image from a modality or a server such as a PACS to an adjustment of resolution, angle of view, gradation, or the like, image processing using supplementary information, or the like may be adopted as an input image to be input to the first estimator.

While the rough extracting unit 42 acquires an estimator trained in advance from the storage unit 34 in the present embodiment, an estimator may be acquired by implementing learning processing described above in the image processing apparatus 100. In other words, the image processing apparatus 100 may acquire a plurality of sets of echocardiograms and correct region data indicating the region of the right ventricle corresponding to the echocardiograms to construct an estimator that estimates the right ventricle region and the rough extracting unit 42 may acquire the constructed estimator.

FIG. 3B shows an example of a right ventricular region 1011 that is an object region to be extracted by the rough extracting unit 42 in step S120. The right ventricular region 1011 extracted by the rough extracting unit 42 becomes a region that overlaps with the right ventricle 1010 and a peripheral site of the right ventricle 1010 in the input image 1001.

(Step S130: Acquisition of Contribution Degree) In step S130, the normalization parameter acquiring unit 43 acquires pixel values of pixels of the object region extracted by rough extraction in step S120. In addition, the normalization parameter acquiring unit 43 calculates and acquires a contribution degree representing a magnitude of a contribution by each pixel toward calculating a normalization parameter in step S140 to be described later.

The contribution degree acquired in the present step will now be described. In the present embodiment, with respect to pixels included in the right ventricular region being the object region extracted by rough extraction in step S120, the contribution degree is acquired in the range of 0 to 1 based on the likelihood calculated by the first estimator. Accordingly, the contribution degree corresponding to the probability that a pixel of interest in the input image is included in the right ventricular region is acquired. In addition, the contribution degree according to the present embodiment is acquired with respect to at least the right ventricular region extracted by the rough extracting unit 42. Specifically, a threshold can be set in advance and the contribution degree can be constituted of binary of 1 or 0 by setting the contribution degree of pixels of which the likelihood calculated by the first estimator is at least the threshold to 1 and setting the contribution degree of pixels of which the likelihood calculated by the first estimator is less than the threshold to 0.

Note that in the present embodiment, a value of the likelihood of pixels in the right ventricular region extracted by rough extraction is used as the contribution degree. However, the contribution degree may be determined by any method including a linear function, a nonlinear function, or a function that can be expressed in the form of y=f (x) as a projection in which a value of a contribution degree y increases with an increase in the value of a likelihood x. In addition, the contribution degree is not limited to a contribution degree that monotonically increases with an increase in the value of likelihood but the contribution degree may be changed as necessary such as becoming a constant in a predetermined likelihood range.

In addition, while a value of the likelihood of pixels in the right ventricular region extracted by rough extraction is used as the contribution degree in the present embodiment, the contribution degree of pixels in the extracted right ventricular region that are deviated from an average value of pixel values of pixels in the extracted right ventricular region may be lowered while the contribution degree of pixels close to the average value may be raised. For example, the contribution degree of each pixel may be calculated in a range that is equal to or greater than 0 and equal to or less than 1 according to a value of a probability density function in a normal distribution based on the average value and standard deviation values of pixel values of pixels in the right ventricular region extracted by rough extraction. In this case, the contribution degree may be determined by additionally performing cutoff processing such as setting the contribution degree to 0 for pixels of which a difference from the average value is more than a constant multiple (for example, three times) the standard deviation value.

(Step S140: Acquisition of Normalization Parameter) In step S140, the normalization parameter acquiring unit 43 calculates and acquires a normalization parameter for normalizing the input image using the pixel value and the contribution degree of each pixel acquired in step S130.

The normalization parameter acquired in the present step will now be described. In the present embodiment, the pixel value of each pixel in the right ventricular region extracted by the rough extraction acquired in step S130 is weighted by the contribution degree and statistic values of pixel values are calculated. Here, an average value and a standard deviation value a are calculated as an example of statistic values. Specifically, the average value and the standard deviation value a are calculated by the following equations (1) and (2). In addition, the values are acquired as normalization parameters. In the equations, i and j denote indices that represent a position of a pixel in the input image and represent a position of an i-th row, j-th column pixel of the input image. Furthermore, w represents a contribution degree of the pixel acquired in step S130 and v denotes a pixel value of the pixel. While a case of calculating the average value and the standard deviation value of pixel values of the respective pixels of an input image as an example of statistic values will be described in the present embodiment, a dispersion value may be adopted in place of the standard deviation value.

$$[ Math . 1 ]$$

$$μ = \frac{{\sum }_{ij} ( {v}_{ij} \times {w}_{ij} )}{{\sum }_{ij} ( {w}_{ij} )} \qquad ( 1 )$$

$$[ Math . 2 ]$$

$$σ = \sqrt{\frac{{\sum }_{ij} {w}_{ij} \times {( {v}_{ij} - μ )}^{2}}{{\sum }_{ij} ( {w}_{ij} )}} \qquad ( 2 )$$

Note that when the contribution degree of each pixel in the right ventricular region acquired in step S130 is constituted of binary of 1 or 0, the processing in the present step corresponds to processing of calculating an average value and a standard deviation value using only pixels of which the contribution degree is 1. In other words, the processing of the present step can be replaced by processing of calculating only for pixels with a contribution degree of 1.

While an example of using the contribution degree as a weight when calculating the average value and the standard deviation value of pixel values in the right ventricular region has been described as an example of calculating a normalization parameter using the contribution degree, implementations of the present invention are not limited thereto. For example, the contribution degree may be used as determination criteria for determining pixels to be used to calculate the normalization parameter. Specifically, the normalization parameter acquiring unit 43 may calculate a maximum value and a minimum value of pixel values with respect to pixels of which the contribution degree acquired in step S130 is at least a predetermined value and acquire the maximum value and the minimum value as normalization parameters.

(Step S150: Normalization of Input Image) In step S150, the normalizing unit 44 normalizes the pixel value of the input image using the normalization parameter acquired in step S140 and acquires a normalized image.

The normalized image acquired in the present step will now be described. In the present embodiment, using the average value and the standard deviation value of pixel values in the right ventricular region which are the normalization parameters acquired in step S140, normalization processing is performed to convert the pixel values of all pixels in the input image so that the average value and the standard deviation value of pixel values in the right ventricular region become values set in advance. As an example, the average value is set to 0 and the standard deviation value is set to 1 as values set in advance. In other words, pixel value conversion processing of converting a statistic value of pixel values in the right ventricular region of the input image into a predetermined statistic value is performed. Specifically, the normalizing unit 44 performs processing of shifting and scaling pixel values.

While a case where a conversion is performed so that the average value and the standard deviation value of pixels after normalization respectively assume values set in advance such as 0 and 1, implementations of the present invention are not limited thereto. For example, the normalizing unit 44 calculates reference values with respect to an average value and a standard deviation value calculated by performing the processing of steps S120, S130, and S140 with respect to a certain reference image that differs from the input image. In addition, the normalizing unit 44 can also perform a conversion such that the average value and the standard deviation value of the pixels of the input image assume the calculated reference values.

While a case of converting a statistic value of pixel values of the input image to a predetermined statistic value has been described as an example above, the conversion may be a conversion that brings the statistic value of the pixel values of the input image closer to the predetermined statistic value. Specifically, the normalizing unit 44 performs processing of rounding, to 8-bit discretized values, the pixel values of the input image after converting the statistic value of the pixel values of the image to a predetermined statistic value. Accordingly, the normalizing unit 44 performs pixel value conversion processing of bringing the statistic value of the pixel values of the input image closer to a predetermined statistic value.

In the present embodiment, a case of performing processing of calculating the average value and the standard deviation value of pixel values of the right ventricular region using the equations (1) and (2) described above as normalization parameters and converting the pixel values so that the average value and the standard deviation value assume values set in advance has been described as an example. However, implementations of the present invention are not limited thereto. For example, the normalizing unit 44 may perform processing of calculating one of the average value and the standard deviation value as a normalization parameter and converting pixel values so that the calculated value assumes a value set in advance. For example, when using the average value of pixel values as the normalization parameter, the normalizing unit 44 can perform conversion processing of shifting the pixel values so that the average value becomes equal to the value set in advance or becomes closer to the set value. In addition, when using the standard deviation value of pixel values as the normalization parameter, the normalizing unit 44 can perform conversion processing of scaling the pixel values so that the standard deviation value becomes equal to the value set in advance or becomes closer to the set value. In both cases, there is an advantage that processing can be simplified as compared to using both the average value and the standard deviation value. Note that cases where the average value or the standard deviation value of the pixel values approximately matches the set value such as when the average value or the standard deviation value is an approximate value of the set value may also be included in cases where the average value or the standard deviation value is the same as the set value.

In addition, when the maximum value and the minimum value of the pixel values are acquired as normalization parameters in step S140, the normalizing unit 44 may convert the pixel values so that the pixel values in the right ventricular region fall within a certain range of pixel values using the acquired maximum and minimum values. Specifically, the normalizing unit 44 linearly converts the pixel values of the input image so that the maximum value of the pixel values in the right ventricular region assume an upper limit value of a range of pixel values set in advance and the minimum value of the pixel values in the right ventricular region assume a lower limit value of the range of pixel values set in advance. Accordingly, an advantage that more robust normalization processing can be realized with respect to missing (overlooked) regions can be gained in the result of the rough estimation of the region in step S120. In addition, the normalizing unit 44 may use an upper limit value and a lower limit value in a certain range of the pixel value distribution as normalization parameters instead of the maximum value and the minimum value of the pixel values. Specifically, the normalizing unit 44 may acquire pixel values of a predetermined percentile when pixel values are arranged in a descending order and pixel values of a predetermined percentile when pixel values are arranged in an ascending order.

Other than the above, the normalizing unit 44 may perform conversion processing of pixel values such that a histogram of pixel values of pixels with a contribution degree of 1 is leveled. Specifically, the normalizing unit 44 calculates, as normalization parameters, a value v(u) that is a cumulative frequency with respect to each pixel value u of pixels of which the contribution degree is 1 divided by the number of pixels of which the contribution degree is 1, and vₘᵢₙ that is a minimum value of pixel values of pixels of which the contribution degree is 1. In addition, using the calculated normalization parameters, the normalizing unit 44 levels the histogram of pixel values according to the following equation (3). Note that in equation (3), L denotes the number of shades of a pixel value and, for example, L is 256 in the case of 8 bits.

$$[ Math . 3 ]$$

$$v = ( v ( u ) - {v}_{min} ) \times \frac{( L - 1 )}{( 1 - {v}_{min} )} \qquad ( 3 )$$

FIG. 3C shows an example of a normalized image 1002 acquired by the normalizing unit 44 in step S150. Due to the processing related to normalization described above, in the normalized image 1002, the right ventricle 1100, the right atrium 1200, the left ventricle 1300, and the left atrium 1400 of the subject are finely drawn and the right ventricle 1100 is finely drawn as compared to the respective sites of the heart drawn in the input image 1001.

(Step S160: Fine Extraction of Object Region) In step S160, the fine extracting unit 45 acquires a second estimator that estimates a region of the object using the normalized image as input from the storage unit 34. In addition, the fine extracting unit 45 inputs the normalized image acquired in step S150 to the second estimator and extracts the region of the object that is an extraction object. While the region of the object extracted by the second estimator in step S160 is similar to step S120, step S160 differs from step S120 in that an image normalized by the method of step S150 is used to extract the region of the object with greater accuracy than the rough extraction described earlier.

Extraction processing of fine extraction that is executed in the present step will now be described. In the present embodiment, the image processing apparatus 100 learns the relationship between a normalized echocardiogram and the right ventricular region in the echocardiogram in advance using CNN in a similar manner to step S120. Subsequently, using the trained CNN, with respect to each pixel of the echocardiogram, the fine extracting unit 45 calculates a likelihood representing a probability that the pixel is the right ventricular region as a value that is equal to or greater than 0 and equal to or less than 1, and using a certain value such as 0.5 as a threshold, the fine extracting unit 45 adopts pixels that are at least the threshold as the extraction region of the right ventricle.

Note that in the present embodiment, echocardiograms with a same resolution are used as input images in steps S120 and S160. However, a low-resolution image with a reduced resolution may be used as the input image in step S120 and a high-resolution image may be used as the input image in step S160 to extract the right ventricular region.

While a case of performing an extraction by fine extraction of the right ventricular region in step S160 has been described as an example above, implementations of the present invention are not limited thereto and an extraction of other anatomical structures may be performed. For example, the fine extracting unit 45 may perform an extraction of a position of the tricuspid valve that is adjacent to the right ventricular region or an extraction of the ventricular apex that is a part of the right ventricular region. In addition, the fine extracting unit 45 is not limited to the extraction of anatomical regions and may also execute an extraction of an abnormal region in an input image and an extraction of foreign objects using a normalized image. Abnormal regions in the input image include regions with predetermined features in the image findings and image feature regions that cannot be differentiated including a mass image, an artifact such as an implanted stent, a surgical scar, and an artifact from imaging and reconstruction.

In addition to the above, the present invention can even be implemented for class classification of input images. For example, the fine extracting unit 45 may execute processing of estimating a presence or absence of disease such as morphological abnormalities or a type of the disease in the right ventricular region. More specifically, the fine extracting unit 45 may execute processing of determining a presence or absence of an enlargement of the right ventricle or a presence or absence of valve insufficiency. In other words, any estimation processing using a normalized image is included in processing by the fine extracting unit 45 according to the present embodiment.

FIG. 3D shows an example of a right ventricular region 1012 to be extracted by the fine extracting unit 45 in step S160. The fine extracting unit 45 inputs the normalized image 1002 in which each site of the heart is more vividly drawn than in the input image 1001 to an estimator. Accordingly, the right ventricular region 1012 extracted by the fine extracting unit 45 becomes a region with a shape that is closer to the right ventricle 1010 in the input image 1001 than the right ventricular region 1011 extracted by the rough extracting unit 42. The fine extracting unit 45 may be described as more finely extracting the region of the object using the normalized image than the rough extracting unit 42.

The processing of the image processing apparatus 100 according to the present embodiment is executed by the processing unit described above. Accordingly, the image processing apparatus 100 can extract a region of the right ventricle that is an extraction object from an echocardiogram with accuracy. In addition, by extracting the right ventricular region by rough extraction and normalizing pixel values using contribution degrees of the pixels based on the extracted region, an effect of reducing variations in pixel values and contrast in the right ventricular region can be produced even when images taken under different imaging conditions are used as input images. Furthermore, by re-extracting the right ventricular region using a normalized image in which variations in pixel values and contrast in the right ventricular region have been reduced (extraction by fine extraction), it is expected that a decline in extraction accuracy of the right ventricular region will be suppressed.

Next, modifications of the embodiment described above will be described. It should be noted that, in the following description, components and processing similar to the components and processing of the image processing apparatus 100 will be denoted by the same reference signs and detailed descriptions thereof will not be repeated.

### Modification 1-1

The first embodiment assumes a case where, using an echocardiogram of a subject taken during echocardiography of a processing object as an input image, the image processing apparatus 100 extracts a region of the right ventricle from the input image. However, the processing of the embodiment described above can be implemented even when images taken of other organs other than the heart or images by other modalities are used as input images.

In the present modification, examples of applying the embodiment described above to an image by another modality include a case where a CT image is used as an input image. In addition, examples of an image of an organ other than the heart include a case where an image taken of an organ such as a lung is used as the input image. Specifically, the input image acquiring unit 41 acquires a CT image taken of a lung as an input image. Then, using the first estimator, the rough extracting unit 42 extracts a region of the lung from the acquired CT image by rough extraction. The normalization parameter acquiring unit 43 acquires a likelihood calculated by the first estimator regarding pixels of the extracted lung region as a contribution degree. In addition, the normalization parameter acquiring unit 43 calculates, based on the acquired contribution degree, an average value and a standard deviation value of the pixel values of pixels of the lung region as normalization parameters. The normalizing unit 44 normalizes the pixel values of the CT image being the input image using the normalization parameter. Furthermore, the fine extracting unit 45 extracts a region of the lung from the normalized CT image by fine extraction.

As a method for calculating the contribution degree, if the pixel value of a pixel in the lung region extracted by rough extraction is close to a statistic value or a theoretical value of a CT value of a general lung region, the contribution degree of the pixel can be calculated to be high, but if the pixel value deviates from the statistic value or the theoretical value of a CT value of a general lung region, the contribution degree can be calculated to be low. Accordingly, when the CT values of some regions in the input image deviate from the original CT value of the lung due to metallic artifacts or the like, the contribution degree of the pixels in the regions can be calculated lower. As a result, the normalizing unit 44 can perform normalization based on pixels indicating the original CT value of the lung region. Note that the modalities, the sites, and the like to be objects of processing in the present modification are not limited to the example described above.

From the above, with the image processing apparatus 100 according to the present modification, even with respect to modalities other than an echocardiogram and object sites other than the heart, a desired region can be extracted from an input image with greater accurately.

### Modification 1-2

The first embodiment assumes a case where, using an echocardiogram of a subject taken during echocardiography of a processing object as input, a region of the right ventricle from the input image is extracted in the image processing apparatus 100. However, the processing of the embodiment described above can be implemented even when images other than medical images are used as input images.

In the present modification, examples of applying the embodiment described above to images other than medical images include a case where an image captured by a camera is used as an input image. Specifically, examples include a case where a region of a face of a person is extracted from an image of the person taken by a camera. The input image acquiring unit 41 acquires an image taken by a camera as the input image. Using the first estimator, the rough extracting unit 42 extracts a region of the face of a person from the input image by rough extraction. The normalization parameter acquiring unit 43 acquires a likelihood calculated by the first estimator with respect to each pixel of the extracted face region as a contribution degree. In addition, the normalization parameter acquiring unit 43 calculates, based on the acquired contribution degree, an average value and a standard deviation value of the pixel values of pixels of the face region as normalization parameters. The normalizing unit 44 normalizes the input image using the normalization parameters. Furthermore, the fine extracting unit 45 extracts a region of the face from the normalized image by fine extraction. A region of the face may be extracted in both rough extraction and fine extraction or an object of extraction may be changed between rough extraction and fine extraction. For example, processing may be performed so that a region of the entire face is extracted in rough extraction and a part of the face such as the eyes, the nose, or the mouth is extracted in fine extraction.

From the above, with the image processing apparatus 100 according to the present modification, by applying the processing described above to an image other than a medical image as an input image, a desired region can be extracted from the image with greater accurately.

### Modification 1-3

While a case where the image processing apparatus 100 uses an estimator based on deep learning such as a CNN as the estimator has been described as an example in the first embodiment, the estimator used in the embodiment described above is not limited thereto. For example, an estimator other than a CNN based on deep learning such as a vision transformer may be used. In this case, using a calculated contribution degree in the processing described above enables processing of the embodiment described above to be implemented.

Alternatively, an estimator based on known methods other than deep learning such as Random Forest or Adaboost may be used. Even in this case, the contribution degree described in the first embodiment can be used in the extraction of a region using the estimator. In this case, viewing the region as pixels encompassed by a contour point cloud, the estimator determines whether or not the point cloud coordinates to be input are “appropriate as contour point cloud coordinates (in other words, positive or negative)”. In addition, a large number of parameters are input to the estimator and candidates determined to be “appropriate as a contour point cloud” are adopted. A region encompassed by a point cloud determined by the estimator to be “appropriate as a contour point cloud” is considered as a region to be extracted by rough extraction and the region is calculated such that the more inside of the region from the contour point cloud, the higher the contribution degree, and the more outside (closer to the contour point cloud or outside the region), the lower the contribution degree. In this manner, according to the present modification, even when using an estimator based on a method other than deep learning for region extraction in the image processing apparatus 100, the processing according to the embodiment described above can be implemented.

### Modification 1-4

While a case where the rough extracting unit 42 inputs an input image to an estimator and extracts a region inside the image is assumed in the first embodiment, processing of the embodiment described above is not limited thereto. For example, a user can input information related to a region that is an extraction object using the operating unit 35 and the rough extracting unit 42 may extract the region based on the input information and the input image.

More specifically, the control unit 40 displays an echocardiogram of the input image acquired by the input image acquiring unit 41 on the display unit 36. In addition, the user operates the operating unit 35 (such as a touch panel) to manually designate a contour point cloud of the right ventricle or a point of a landmark as information related to the region of the right ventricle. The rough extracting unit 42 inputs the information related to the region of the right ventricle input by the user and an echocardiogram to the first estimator and acquires a right ventricular region extracted by rough extraction from the input image. Subsequent processing is the same as in the first embodiment.

Accordingly, with the image processing apparatus 100 according to the present modification, by also using information on the region of the extraction object input by the user as input to the estimator instead of only inputting an image to the estimator, a desired region can be extracted from the input image with higher accuracy.

### Modification 1-5

While the normalizing unit 44 normalizes the pixel value of the input image using the normalization parameter and acquires a normalized image in the first embodiment, processing of the embodiment described above is not limited thereto. For example, the user may input information related to a region to be extracted by rough extraction and information related to a likelihood related to the region to be extracted and the normalizing unit 44 may normalize an input image based on the pieces of information input by the user.

A specific example will be described below. First, the control unit 40 displays an echocardiogram of an input image acquired by the input image acquiring unit 41 on the display unit 36. In addition, the user operates the operating unit 35 (such as a touch panel) to manually designate a region of the right ventricle as a region to be extracted by rough extraction. Furthermore, the user inputs, with respect to the designated region of the right ventricle, a certainty factor of being the right ventricle. At this point, the normalization parameter acquiring unit 43 acquires a likelihood of each pixel by setting the likelihood of a pixel considered by the user to have a high certainty factor to 1, the likelihood of a pixel considered to have a low certainty factor to 0.5, and the like. In addition, the normalization parameter acquiring unit 43 calculates the contribution degree of each pixel based on the acquired likelihood and acquires a normalization parameter based on the contribution degree. Subsequent processing is the same as in the first embodiment.

Accordingly, with the image processing apparatus 100 according to the present modification, normalization of pixel values based on the likelihood of the region of the right ventricle can be performed using information on a region extracted by rough extraction input by the user instead of an extraction of a region using an estimator by the rough extracting unit 42.

### Second Embodiment

Next, an image processing apparatus according to a second embodiment will be described. It should be noted that, in the following description, components and processing similar to the components and processing described above of the image processing apparatus according to the first embodiment will be denoted by the same reference signs and detailed descriptions thereof will not be repeated.

An image processing apparatus according to the second embodiment is an apparatus that uses an image in which an object is depicted as an input image and extracts a region of the object from the input image in a similar manner to the first embodiment. The image processing apparatus 100 according to the first embodiment calculates a contribution degree based on a likelihood of each pixel based on the region of the object extracted by rough extraction. On the other hand, the image processing apparatus according to the present embodiment reduces the region extracted by rough extraction and calculates a contribution degree based on pixels of the reduced region.

In the present embodiment, an echocardiogram of a subject taken during echocardiography is used as an input image, and using the right ventricle in the input image as the object, a region of the right ventricle is extracted in a similar manner to the first embodiment.

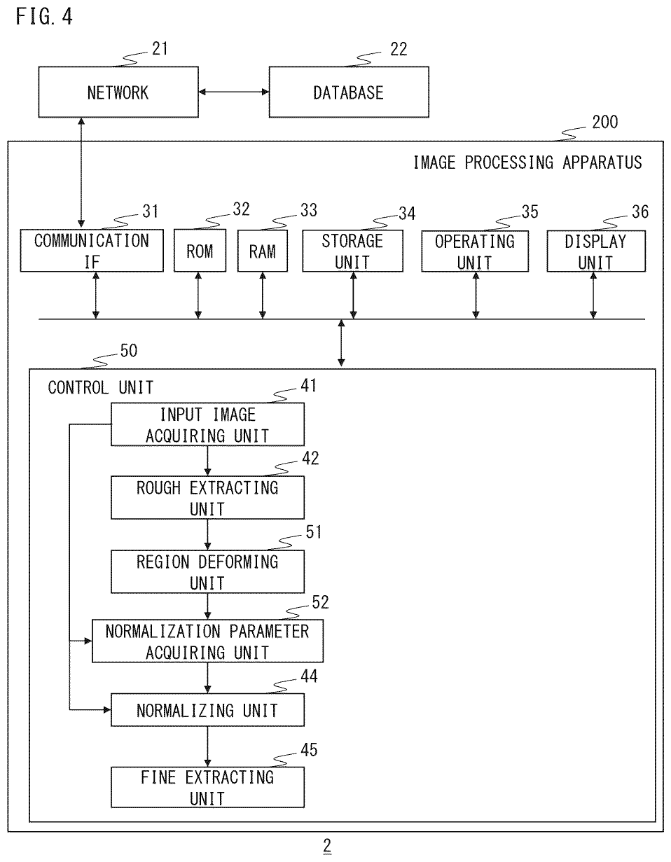

Hereinafter, a configuration of the image processing apparatus according to the present embodiment will be described with reference to FIG. 4. As shown in FIG. 4, an image processing system 2 includes an image processing apparatus 200 and the database 22. The image processing apparatus 200 according to the present embodiment differs from the image processing apparatus 100 according to the first embodiment in that the image processing apparatus 200 includes a region deforming unit 51 and a normalization parameter acquiring unit 52. Hereinafter, processing by each processing unit of the image processing apparatus 200 will be described with a focus on differences from the processing in the first embodiment.

The region deforming unit 51 is a deformed region acquiring unit which acquires, by performing deformation processing such as reducing or enlarging an object region extracted by the rough extracting unit 42 by rough extraction, a deformed region of the object region.

The normalization parameter acquiring unit 52 acquires a pixel value of a pixel based on the deformed region acquired by the region deforming unit 51 and calculates a contribution degree representing a magnitude of an influence (contribution) exerted by the pixel on the normalization performed by the normalizing unit 44. In addition, using the acquired pixel value and the calculated contribution degree, the normalization parameter acquiring unit 52 calculates and acquires the normalization parameter to be used in the normalizing unit 44.

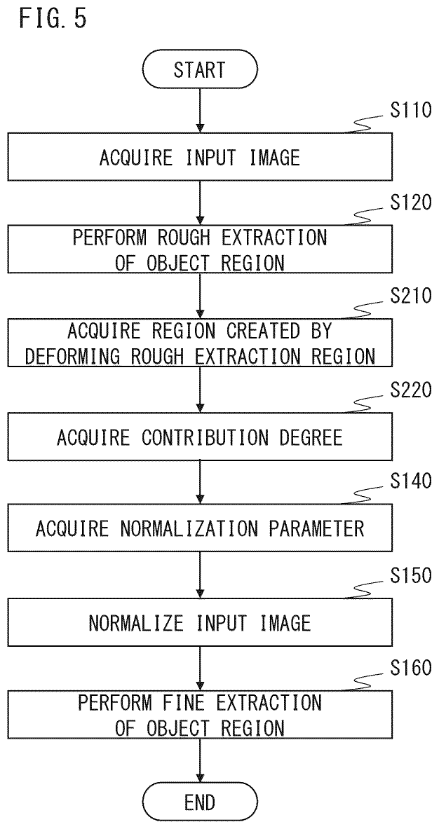

Next, an example of processing executed by the image processing apparatus 200 according to the present embodiment will be described in detail with reference to the flow chart shown in FIG. 5. As shown in FIG. 5, the processing executed by the image processing apparatus 200 has processing of step S210 of deforming a region extracted by rough extraction has been added to the processing of the flow chart according to the first embodiment shown in FIG. 2 and differs in processing contents of step S220 which corresponds to step S130.

(Step S210: Acquisition of Region Created by Deforming Rough Extraction Region) In step S210, the region deforming unit 51 acquires, by reducing or enlarging the object region extracted by rough extraction in step S120, a deformed region of the object region.

In the present embodiment, the region deforming unit 51 acquires, as a deformed region, a region that is a reduction by a certain percentage determined in advance of the right ventricular region extracted by rough extraction in step S120. Instead of acquiring a region that reduces the right ventricular region as the deformed region, the region deforming unit 51 may acquire a region that enlarges the right ventricular region by a certain percentage determined in advance may be acquired as the deformed region.

In addition, while the region deforming unit 51 reduces the right ventricular region by a certain percentage determined in advance in the present embodiment, alternatively, the region deforming unit 51 may change a reduction rate for each site of the right ventricular region extracted by rough extraction in step S120. For example, the region deforming unit 51 may determine a reduction rate for each site of the right ventricular region based on a reliability of rough extraction of the right ventricular region. Here, the reliability of rough extraction can be defined as an accuracy of extraction of the object region by the rough extracting unit 42. The region deforming unit 51 may make the reduction rate greater with respect to sites with lower reliability and make the reduction rate smaller with respect to sites with higher reliability. Specifically, the region deforming unit 51 determines the reduction rate so that the reliability is higher when the likelihood of each pixel in the right ventricular region calculated by the first estimator is higher and the reliability is lower when the likelihood is lower. In addition, the reliability of rough extraction may be determined based on a spatial gradient of pixels near the contour of the right ventricular region extracted by rough extraction. For example, the reliability may be set high when the spatial gradient is large and set low when the gradient is small.

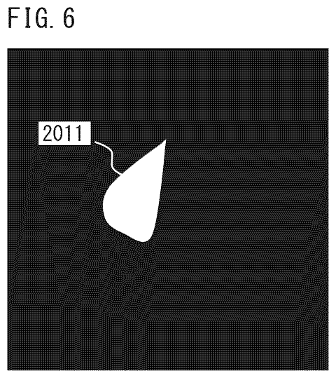

FIG. 6 shows an example of a deformed region 2011 acquired by the region deforming unit 51 in step S210. Note that the input image in the present embodiment is the input image 1001 in FIG. 3A. As shown in FIG. 6, the deformed region 2011 acquired by the region deforming unit 51 is a region in which the right ventricular region 1011 extracted by the rough extracting unit 42 is reduced in the first embodiment.

(Step S220: Acquisition of Contribution Degree) In step S220, the normalization parameter acquiring unit 52 acquires a pixel value of a pixel based on the deformed region acquired in step S210 and calculates and acquires a contribution degree representing a contribution by the pixel toward calculating a normalization parameter in step S140.

In the present embodiment, the contribution degree is binarized with a value indicating a region acquired by reducing the object region and a value indicating a region outside of the region acquired by reducing the object region. Specifically, the normalization parameter acquiring unit 52 acquires the contribution degree of a pixel included in the right ventricular region reduced in step S210 as 1 and the contribution degree of a pixel in other regions as 0. Note that the normalization parameter acquiring unit 52 may calculate a normalization parameter based on a pixel value of a pixel in the region reduced in step S140 instead of acquiring a contribution degree based on the reduced right ventricular region. Accordingly, the normalization parameter acquiring unit 52 can acquire a normalization parameter for performing normalization of an input image based on a partial region that is a part of the object region.

Note that in the present embodiment, the contribution degree of a pixel included in the reduced right ventricular region is set to 1 and the contribution degree of a pixel in other regions is set to 0. Furthermore, the contribution degrees of pixels in a region (in other words, the region that has become outside the region due to the reduction of the right ventricular region) between the reduced right ventricular region (in other words, the deformed region: contribution degree=1) and the region (contribution degree=0) of pixels outside the right ventricular region may be set continuously between 0 and 1. In this case, the contribution degree between 0 and 1 to be set between the deformed region and the region outside the right ventricular region may be set so that the closer to the deformed region, the larger the value, and the closer to the region outside the right ventricular region, the smaller the value. Therefore, the normalization parameter acquiring unit 52 calculates contribution degrees based on both the deformed region and the rough extraction region.

In addition, when a region created by enlarging the right ventricular region extracted by rough extraction in step S210 is acquired as the deformed region, the contribution degree of a pixel inside the enlarged right ventricular region may be acquired as 0 and the contribution degree of a pixel in other regions may be acquired as 1. In this case, by setting the contribution degree of pixels outside of the enlarged right ventricular region to 1, the normalizing unit 44 performs normalization based on a background region other than the right ventricle. According to this configuration, by normalizing the pixel values of the background region of the right ventricle, the background region and the region of the right ventricle that is an extraction object can be more clearly distinguished and the accuracy of extraction by fine extraction in step S160 can be improved.

In the present embodiment, performing the normalization described above using the deformed region 2011 acquired by the region deforming unit 51 enables the normalizing unit 44 to acquire the normalized image 1002 shown in FIG. 3C in step S150. In addition, in step S160, the fine extracting unit 45 can input the normalized image 1002 in the estimator and extract the right ventricular region 1012 shown in FIG. 3D.

Due to the processing of the image processing apparatus 200 according to the present embodiment described above, normalization with an emphasis on a region that is highly likely to be an object in a region extracted by rough extraction from an input image can be performed.

Next, modifications of the embodiment described above will be described. It should be noted that, in the following description, components and processing similar to the components and processing of the image processing apparatus 200 will be denoted by the same reference signs and detailed descriptions thereof will not be repeated.

### Modification 2-1

While a case of using an estimator based on deep learning such as a CNN in the rough extracting unit 42 in step S120 is assumed in the second embodiment, the user may operate the operating unit 35 and manually designate a region to be an object of rough extraction and the rough extracting unit 42 may extract the designated region.

For example, a control unit 50 displays an echocardiogram that is the input image acquired by the input image acquiring unit 41 on the display unit 36 and, by having the user manually designate a region of the right ventricle via the operating unit 35 (a touch panel or the like), information on the right ventricular region that is an object of rough extraction is acquired. Next, based on the acquired information on the right ventricular region, the region deforming unit 51 acquires a region created by reducing the right ventricular region drawn in the input image as the deformed region. In addition, based on the acquired information on the right ventricular region, the normalization parameter acquiring unit 52 sets the contribution degree of pixels outside of the region designated by the user to 0 and the contribution degree of pixels in the deformed region to 1 and continuously sets the contribution degree of pixels in a region between a contour of the region designated by the user and a contour of the deformed region from 0 to 1. Subsequent processing is the same as in the second embodiment.

In the description given above, a case where the user operates the operating unit 35 to manually designate a region to be extracted by rough extraction was described as an example. However, the region of the rough extraction is not limited to being manually designated and the rough extracting unit 42 may acquire information on the right ventricular region stored in the database 22 and the storage unit 34 as the region of the rough extraction. Accordingly, by having the image processing apparatus 200 execute the processing described above, the fine extracting unit 45 can extract the right ventricular region more finely based on the information on the right ventricular region manually designated by the user. Therefore, the image processing apparatus 200 can use the information on the region that is an extraction object designated by the user in extraction processing by fine extraction according to the processing described above.

### Third Embodiment

Next, an image processing apparatus according to a third embodiment will be described. It should be noted that, in the following description, components and processing similar to the components and processing described above of the image processing apparatus according to the embodiments described above will be denoted by the same reference signs and detailed descriptions thereof will not be repeated.

An image processing apparatus according to the third embodiment is an apparatus that uses an image in which an object is depicted as an input image and extracts a region of the object from the input image in a similar manner to the first and second embodiments. The image processing apparatus 200 according to the second embodiment calculates a contribution degree based on a deformed region created by deforming the region of the object extracted by rough extraction. However, the image processing apparatus according to the present embodiment calculates a contribution degree based on, for example, pixels of a region that is smaller than the region extracted by rough extraction.

In the present embodiment, a case where an echocardiogram of a subject taken during echocardiography is used as an input image, and using the right ventricle in the input image as the object, a region of the right ventricle is extracted is assumed in a similar manner to the first and second embodiments.

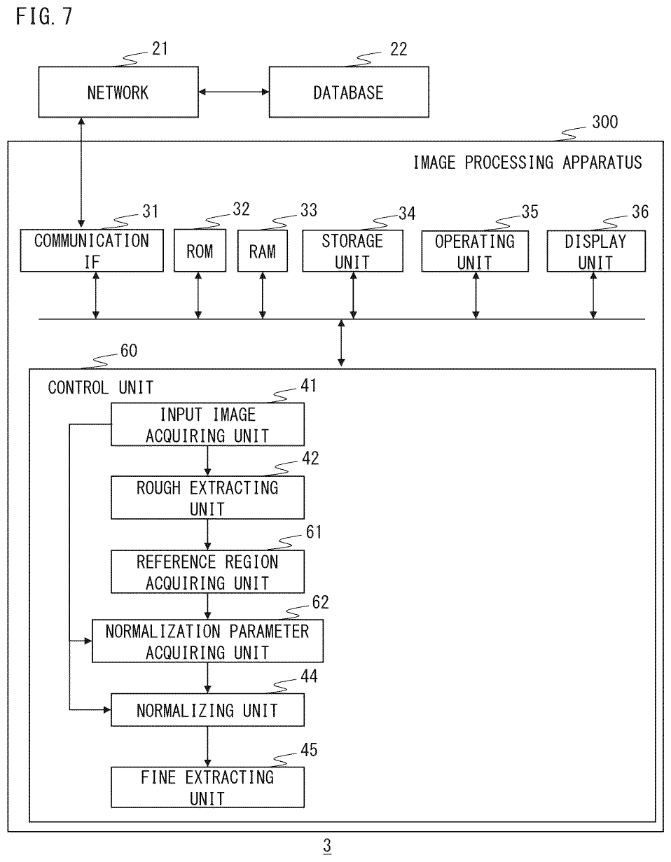

Hereinafter, a configuration of the image processing apparatus according to the present embodiment will be described with reference to FIG. 7. As shown in FIG. 7, an image processing system 3 includes an image processing apparatus 300 and the database 22. The image processing apparatus 300 according to the present embodiment differs from the image processing apparatus 100 according to the first embodiment in that the image processing apparatus 300 includes a reference region acquiring unit 61 and a normalization parameter acquiring unit 62. Hereinafter, processing by each processing unit of the image processing apparatus 300 will be described with a focus on differences from the processing in the embodiments described above.

The reference region acquiring unit 61 is a deformed region acquiring unit that acquires, as a reference region, a region which is created by deforming an object region determined based on an extraction accuracy of an object by the rough extracting unit 42 and which is smaller than the rough extraction region.

The normalization parameter acquiring unit 62 acquires a pixel value of a pixel based on the reference region acquired by the reference region acquiring unit 61 and calculates a contribution degree representing a magnitude of an influence (contribution) exerted by the pixel on the normalization performed by the normalizing unit 44. In addition, using the acquired pixel value and the calculated contribution degree, the normalization parameter acquiring unit 62 calculates and acquires the normalization parameter to be used in the normalizing unit 44.

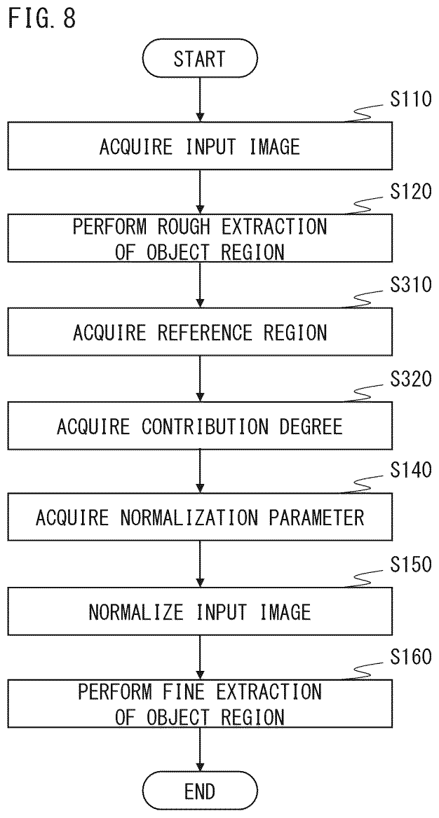

Next, an example of processing executed by the image processing apparatus 300 will be described in detail with reference to the flow chart shown in FIG. 8. As shown in FIG. 8, the processing executed by the image processing apparatus 300 has processing of step S310 of acquiring a reference region added to the processing of the flow chart according to the first embodiment shown in FIG. 2 and differs in processing contents of step S320 which corresponds to step S130.

(Step S310: Acquire Reference Region) In step S310, based on a region (rough extraction region) extracted by rough extraction acquired in step S120, the reference region acquiring unit 61 acquires a region smaller than the rough extraction region.

In the present embodiment, as an example, a case where the extracted region extracted by the rough extracting unit 42 has a property that the extraction accuracy of a given region (in this case, a region including the lower 30% of the region) of the region becomes higher is assumed. In this case, the reference region acquiring unit 61 acquires a region that is the lower 30% of the extracted region of the right ventricular region extracted by rough extraction in step S120 as a reference region. In addition, in another example, instead of the region that is the lower 30% of the extracted region, the reference region acquiring unit 61 may acquire, as a reference region, a region which is created by enlarging the region that is the lower 30% of the extracted region at a rate determined in advance in a direction where the contour of the right ventricle is formed and which excludes the lower 30% of the extracted region. In other words, the reference region acquiring unit 61 may acquire a region of myocardium outside the right ventricular region as the reference region.

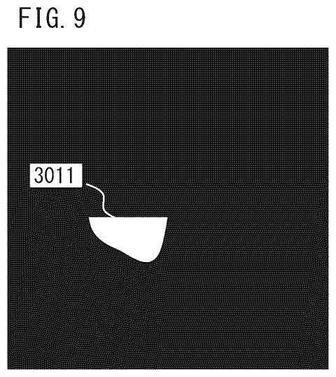

FIG. 9 shows an example of a reference region 3011 acquired by the reference region acquiring unit 61 in step S310. Note that the input image in the present embodiment is the input image 1001 in FIG. 3A. As shown in FIG. 9, the reference region 3011 acquired by the reference region acquiring unit 61 is a region which is created by removing a region that is the upper 70% and only the lower 30% remains in the right ventricular region 1011 extracted by the rough extracting unit 42 as in the first embodiment.

(Step S320: Acquisition of Contribution Degree) In step S320, the normalization parameter acquiring unit 62 acquires a pixel value of a pixel based on the reference region acquired in step S310 and calculates and acquires a contribution degree representing a contribution by the pixel toward calculating a normalization parameter in step S140.

In the present embodiment, the normalization parameter acquiring unit 62 acquires the contribution degree of a pixel included in the region that is the lower 30% of the right ventricular region extracted by rough extraction that is the reference region calculated in step S310 as 1 and the contribution degree of a pixel in other pixel regions as 0. Note that the normalization parameter acquiring unit 62 may calculate the contribution degree of a bottommost pixel in the right ventricular region extracted by rough extraction to be 1 and continuously decrease the contribution degree within a range of 0 to 1 toward the top of the region so that the contribution degree of a pixel in the lower 30% of the region is 0.5.

In the present embodiment, performing the normalization described above using the reference region 3011 acquired by the reference region acquiring unit 61 enables the normalizing unit 44 to acquire the normalized image 1002 shown in FIG. 3C in step S150. In addition, in step S160, the fine extracting unit 45 can input the normalized image 1002 in the estimator and extract the right ventricular region 1012 shown in FIG. 3D.

According to the processing of the image processing apparatus 300 according to the present embodiment described above, a region near a certain site in the right ventricular region extracted by rough extraction is used as a reference region and pixel values of the reference region are normalized. Accordingly, in the image processing apparatus 300, even if a region in which the extraction accuracy of rough extraction is high is biased in a certain site, the right ventricle related to the reference region can be accurately extracted from an input image.

### Fourth Embodiment

Next, an image processing apparatus according to a fourth embodiment will be described. It should be noted that, in the following description, components and processing similar to the components and processing described above of the image processing apparatus according to the embodiments described above will be denoted by the same reference signs and detailed descriptions thereof will not be repeated.

The image processing apparatus according to the fourth embodiment is an apparatus that uses an image in which an object is depicted as an input image and extracts a region of the object from the input image in a similar manner to the first, second, and third embodiments. The image processing apparatus 100 according to the first embodiment calculates a contribution degree using a likelihood of each pixel based on the region of the object extracted by rough extraction. However, the image processing apparatus according to the fourth embodiment acquires, for example, information regarding extraction accuracy of rough extraction by an estimator that is executed by the rough extracting unit as a contribution degree. In addition, in an example of a case where an echocardiogram of a subject taken during echocardiography is used as an input, the image processing apparatus according to the present embodiment uses the right ventricle in the input image as the object and extracts a region of the right ventricle in a similar manner to the first to third embodiments.

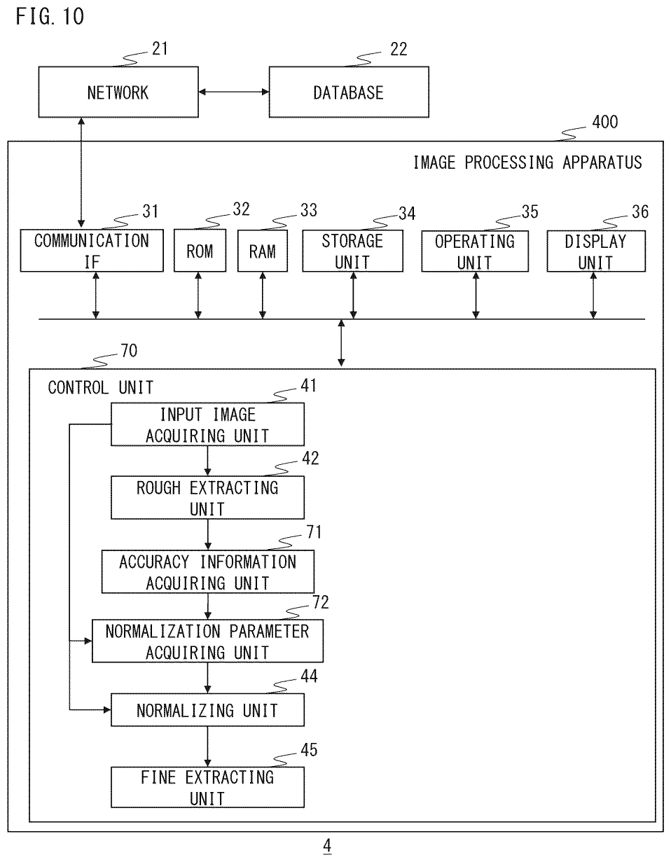

Hereinafter, a configuration of the image processing apparatus according to the present embodiment will be described with reference to FIG. 10. As shown in FIG. 10, an image processing system 4 includes an image processing apparatus 400 and the database 22. The image processing apparatus 400 according to the present embodiment differs from the image processing apparatus 100 according to the first embodiment in that the image processing apparatus 400 includes an accuracy information acquiring unit 71 and a normalization parameter acquiring unit 72. Hereinafter, processing by each processing unit of the image processing apparatus 400 will be described with a focus on differences from the processing in the embodiments described above.

The accuracy information acquiring unit 71 acquires information regarding an extraction accuracy of a region of the object extracted by rough extraction by the rough extracting unit 42 from the database 22 or the storage unit 34.

The normalization parameter acquiring unit 72 calculates a contribution degree that represents a magnitude of an influence (contribution) exerted by a pixel of the object region extracted by the rough extracting unit 42 on the normalization performed by the normalizing unit 44 based on the information regarding the extraction accuracy of the region of the object acquired by the accuracy information acquiring unit 71. In addition, using the pixel value and the calculated contribution degree of the pixel based on the object region, the normalization parameter acquiring unit 72 calculates and acquires the normalization parameter to be used in the normalizing unit 44.

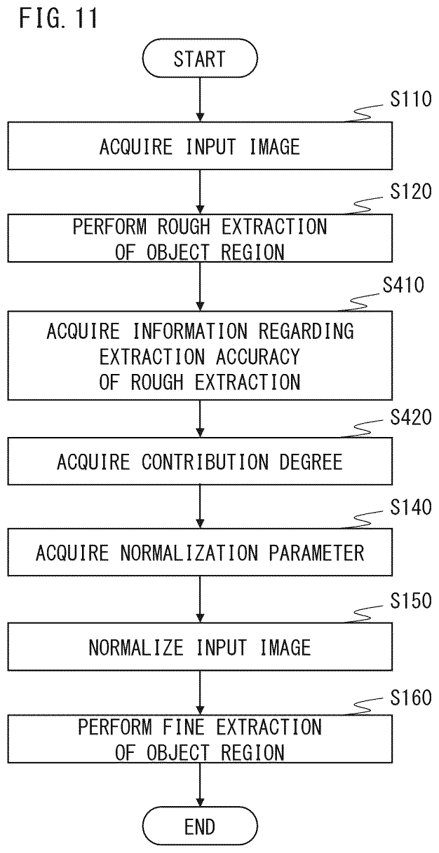

Next, an example of processing executed by the image processing apparatus 400 will be described in detail with reference to the flow chart shown in FIG. 11. As shown in FIG. 11, the processing executed by the image processing apparatus 400 has processing of step S410 of acquiring information regarding rough extraction accuracy added to the processing of the flow chart according to the first embodiment shown in FIG. 2 and differs in processing contents of step S420 which corresponds to step S130.

(Step S410: Acquisition of Information Regarding Extraction Accuracy of Rough Extraction) In step S410, the accuracy information acquiring unit 71 acquires information regarding accuracy of the first estimator that extracts a region of an object in step S120. Accordingly, the accuracy information acquiring unit 71 acquires information regarding an extraction accuracy of an object region when the rough extracting unit 42 extracts the object region by rough extraction.

Examples of a method of acquiring information regarding the accuracy of the first estimator in the present step include a method of executing processing of assessing the accuracy of the first estimator and acquiring an assessment result as the information regarding the accuracy of the first estimator. Specifically, first, apart from the input image acquired in step S110, the accuracy information acquiring unit 71 acquires an assessment image that defines a correct right ventricular region in the image. In addition, the accuracy information acquiring unit 71 acquires an assessment result of the region of the right ventricle using the estimator executed by the rough extracting unit 42 with respect to the assessment image. Furthermore, the accuracy information acquiring unit 71 compares the correct right ventricular region in the assessment image with an estimation result of the region by the first estimator.

At this point, based on a comparison result, the accuracy information acquiring unit 71 acquires an assessment result indicating that the accuracy of the first estimator is low with respect to a site in which a difference between the regions is large and that the accuracy of the first estimator is high with respect to a site in which a difference between the regions is small. Here, the difference between the correct region and the region due to estimation can be acquired based on a magnitude of the difference in the contour positions of the regions, a value of the likelihood output by the first estimator, and the like. In addition, the difference between the correct region and the region due to estimation is desirably acquired separately for each of a plurality of sites that make up the right ventricle. Specifically, a site near the tricuspid valve, a site near the apex, a site between the tricuspid valve and the apex, and the like in the right ventricle can be considered the plurality of sites. Therefore, the accuracy information acquiring unit 71 can acquire the information regarding the accuracy of the first estimator with respect to each of the plurality of sites constituting the right ventricle.

Furthermore, in the description given above, the accuracy information acquiring unit 71 acquires a difference between the correct right ventricular region in the assessment image and the right ventricular region as estimated by the first estimator. However, the accuracy information acquiring unit 71 may acquire a plurality of assessment images, calculate a difference between the correct right ventricular region and the right ventricular region as estimated by the first estimator with respect to each of the assessment images, and acquire an assessment result of the first estimator based on the calculated difference. Specifically, the accuracy information acquiring unit 71 acquires an assessment result of the accuracy of the first estimator based an average value, an initial value, a maximum value, or the like of differences between correct regions and estimated regions with respect to the respective assessment images.

Otherwise, the accuracy information acquiring unit 71 may acquire, of the right ventricular region estimated by the first estimator for each evaluation image, the percentage of each site that fails to be extracted may be acquired as information about the extraction accuracy of the first estimator. Specifically, accuracy information acquiring unit 71 acquires, as information regarding the extraction accuracy of the first estimator, the percentage of sites close to the apex of the heart that fail to be extracted, the percentage of sites close to the tricuspid valve that fail to be extracted, and the percentage of sites between these sites that fail to be extracted in a plurality of assessment images. In this case, a failure of each site to be extracted means an occurrence of missing extraction such as not extracting the region of each site, the difference between the above regions exceeding a predetermined criterion, and the like.

(Step S420: Acquisition of Contribution Degree) In step S420, the normalization parameter acquiring unit 72 identifies a plurality of sites drawn in a region of an object extracted by rough extraction. Next, the normalization parameter acquiring unit 72 acquires a pixel value of a pixel based on the region of the object acquired in step S120 and calculates and acquires a contribution degree based on the information regarding the accuracy of the first estimator that extracts the region of the object acquired in step S410.

In the present embodiment, the normalization parameter acquiring unit 72 identifies a plurality of sites that constitute the right ventricle from the right ventricular region extracted by rough extraction acquired in step S120 and calculates a contribution degree based on error information of each site that constitutes the right ventricle acquired in step S410. Specifically, in the right ventricular region extracted by rough extraction, the normalization parameter acquiring unit 72 identifies, as sites that constitute the right ventricle, the upper 30% of the right ventricle as a site near the apex, the lower 30% of the right ventricle as a site near the tricuspid valve, and all but the upper 30% and lower 30% of the right ventricle as a site between the apex and tricuspid valve. In addition, the normalization parameter acquiring unit 72 calculates contribution degrees so that the contribution degree of a site with a large error regarding each site constituting the right ventricle is small and the contribution degree of a site with a small error regarding each site constituting the right ventricle is large. Accordingly, the normalization parameter acquiring unit 72 calculates a contribution degree correlated to the first estimator that extracts the region of the object acquired in step S120. While the normalization parameter acquiring unit 72 identifies the plurality of sites constituting the right ventricle based on their relative positions in the overall region of the right ventricle such as the upper and lower parts of the right ventricle in the present embodiment, each site may be identified using a discriminator that classifies each site.

Note that the input image in the present embodiment is the input image 1001 in FIG. 3A. In addition, the right ventricular region 1011 shown in FIG. 3B is extracted by the rough extracting unit 42 in step S120. Furthermore, by performing the normalization described above using the contribution degree calculated based on information regarding extraction accuracy according to the rough extracting unit 42 and the right ventricular region 1011, the normalizing unit 44 can acquire the normalized image 1002 shown in FIG. 3C in step S150. In addition, in step S160, the fine extracting unit 45 can input the normalized image 1002 in the estimator and extract the right ventricular region 1012 shown in FIG. 3D.

As described above, with the image processing apparatus 400 according to the present embodiment, since a contribution degree can be calculated based on a tendency of erroneous estimation of the first estimator that performs rough extraction, the contribution degree of a pixel value of a site that is less likely to be erroneously estimated can be increased. Accordingly, by generating a normalized image with a higher contribution degree of pixel values in a more accurate region as a correct right ventricular region, the image processing apparatus 400 is expected to improve the accuracy of extraction of the right ventricular region with respect to an input image.

The technique according to the present disclosure can improve accuracy of region extraction of an object with respect to an image taken of the object.

The technique according to the present disclosure can be implemented as, for example, a system, an apparatus, a method, a program, or a recording medium (storage medium). Specifically, the technique according to the present disclosure may be applied to a system including a plurality of devices (for example, a host computer, an interface device, an image capturing apparatus, and a web application) or may be applied to an apparatus constituted by a single device.

Needless to say, the object of the technique according to the present disclosure is achieved by the following configurations. That is, a recording medium (or a storage medium) storing a program code (computer program) of software for realizing the functions of the above-described embodiments is supplied to a system or an apparatus. Obviously, the storage medium is a computer-readable storage medium. Next, a computer (or a CPU or MPU) of the system or the apparatus reads out and executes the program code stored in the recording medium. In this case, the recording medium in which the program code read out from the recording medium is recorded constitutes the technique of the present disclosure.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-020566, filed on Feb. 14, 2024, which is hereby incorporated by reference herein in its entirety.

What is claimed is:

1. An image processing apparatus, comprising:
a processor; and
a memory storing a program which, when executed by the processor, causes the image processing apparatus to
execute image acquisition processing of acquiring an image taken of an object,
execute first extraction processing of extracting a first region in correspondence with a region of the object by using the image,
execute parameter acquisition processing of acquiring a parameter for performing normalization of the image, based on a pixel value of a pixel in the first region and based on a contribution degree indicating a probability that the pixel is included in the object,
execute normalization processing of acquiring a normalized image created by normalizing the image by using the image and the parameter, and
execute second extraction processing of more finely extracting a region of the object than the first region by using the normalized image.

2. The image processing apparatus according to claim 1, wherein the program,
when executed by the processor, further causes the image processing apparatus to execute contribution degree acquisition processing of acquiring information on the contribution degree.

3. The image processing apparatus according to claim 1, wherein the contribution degree is correlated with an extraction accuracy with which the first extraction processing extracts a region of the object.

4. The image processing apparatus according to claim 1, wherein
the first extraction processing extracts the first region by using a machine learning model having been trained to extract a region of the object from an image, and
the contribution degree is based on a likelihood of the object of the pixel with respect to the first region extracted by the machine learning model.

5. The image processing apparatus according to claim 1, wherein the contribution degree is binarized with a value indicating a region created by reducing the first region and a value indicating a region outside of the region created by reducing the first region.

6. The image processing apparatus according to claim 1, wherein the contribution degree is a value that is equal to or greater than 0 and equal to or less than 1, and a region of which the contribution degree is equal to or greater than 0.5 is smaller than the first region extracted by the first extraction processing.

7. The image processing apparatus according to claim 6, wherein a region of which the contribution degree is equal to or greater than 0.5 includes a region that overlaps with the first region that is extracted by the first extraction processing.

8. The image processing apparatus according to claim 6, wherein a region of which the contribution degree is equal to or greater than 0.5 is a region inside the first region that is extracted by the first extraction processing.

9. The image processing apparatus according to claim 1, wherein the parameter is a statistic value regarding a pixel value of each pixel of an image acquired by the image acquisition processing.

10. The image processing apparatus according to claim 9, wherein the statistic value includes at least an average value and a dispersion value or a standard deviation value of the pixel values.

11. The image processing apparatus according to claim 9, wherein the normalization processing performs a pixel value conversion of bringing the statistic value of a pixel, acquired by the image acquisition processing, close to a predetermined statistic value.

12. The image processing apparatus according to claim 9, wherein the statistic value includes at least an upper limit value and a lower limit value in a certain range of a pixel value distribution.

13. The image processing apparatus according to claim 1, wherein the program, when executed by the processor, further causes the image processing apparatus to execute deformed region acquisition processing of acquiring a deformed region created by deforming the first region extracted by the first extraction processing, and
the contribution degree indicates a correlation between the pixel and the object in the deformed region.

14. The image processing apparatus according to claim 13, wherein the deformed region acquisition processing determines a ratio of deforming the first region, based on an extraction accuracy of a region of the object by the first extraction processing and deforms the first region, based on the ratio.

15. The image processing apparatus according to claim 13, wherein the deformed region acquisition processing deforms the first region so as to include a predetermined region in the first region that is determined based on an extraction accuracy of a region of the object by the first extraction processing.

16. The image processing apparatus according to claim 1, wherein the image includes an ultrasonic image.

17. The image processing apparatus according to claim 1, wherein the object includes at least any of a part of a heart and a region having a predetermined feature included in the image.

18. The image processing apparatus according to claim 1, wherein the first extraction processing extracts the first region from the image.

19. The image processing apparatus according to claim 1, wherein the second extraction processing more finely extracts a region of the object from the image than the first region.

20. The image processing apparatus according to claim 1, wherein the second extraction processing more finely extracts a region of the object by using the normalized image than the first extraction processing.

21. The image processing apparatus according to claim 2, wherein the contribution degree acquisition processing acquires the contribution degree at least with respect to the pixel that corresponds to the first region.

22. An image processing apparatus, comprising:
a processor; and
a memory storing a program which, when executed by the processor, causes the image processing apparatus to
execute image acquisition processing of acquiring an image taken of an object,
execute first extraction processing of extracting a region of the object as a first region by using the image,
execute parameter acquisition processing of acquiring a parameter for performing normalization of the image, based on a partial region that is a part of the first region,
execute normalization processing of acquiring a normalized image created by normalizing the image by using the image and the parameter, and
execute second extraction processing of extracting a region of the object by using the normalized image.

23. An image processing method, comprising:
an image acquisition step of acquiring an image taken of an object;
a first extraction step of extracting a first region in correspondence with a region of the object by using the image;
a parameter acquisition step of acquiring a parameter for performing normalization of the image, based on a pixel value of a pixel in the first region and based on a contribution degree indicating a probability that the pixel is included in the object;
a normalization step of acquiring a normalized image created by normalizing the image by using the image and the parameter; and
a second extraction step of more finely extracting a region of the object than the first region by using the normalized image.

24. An image processing method, comprising:
an image acquisition step of acquiring an image taken of an object;
a first extraction step of extracting a region of the object as a first region by using the image;
a parameter acquisition step of acquiring a parameter for performing normalization of the image, based on a partial region that is a part of the first region;
a normalization step of acquiring a normalized image created by normalizing the image by using the image and the parameter; and
a second extraction step of extracting a region of the object by using the normalized image.

25. A non-transitory computer readable medium that stores a program, wherein the program causes a computer to execute an image processing method, the image processing method comprising:
an image acquisition step of acquiring an image taken of an object;
a first extraction step of extracting a first region in correspondence with a region of the object by using the image;
a parameter acquisition step of acquiring a parameter for performing normalization of the image, based on a pixel value of a pixel in the first region and based on a contribution degree indicating a probability that the pixel is included in the object;
a normalization step of acquiring a normalized image created by normalizing the image by using the image and the parameter; and
a second extraction step of more finely extracting a region of the object than the first region by using the normalized image.

26. A non-transitory computer readable medium that stores a program, wherein the program causes a computer to execute an image processing method, the image processing method comprising:
an image acquisition step of acquiring an image taken of an object;
a first extraction step of extracting a region of the object as a first region by using the image;
a parameter acquisition step of acquiring a parameter for performing normalization of the image, based on a partial region that is a part of the first region;
a normalization step of acquiring a normalized image created by normalizing the image by using the image and the parameter; and
a second extraction step of extracting a region of the object by using the normalized image.
